(19) United States
(12) Patent Application Publication
(10) Pub. No.: US 2011/0273255 A1
(43) Pub. Date: Nov. 10, 2011

(54) ENDOSKELETAL TRANSFORMER TANK

(76) Inventor: Robert Samuel Thompson, Matthews, NC (US)

(21) Appl. No.: 12/776,491

(22) Filed: May 10, 2010

(51) Int. Cl. H01F 27/02; B65D 1/46; B65D 1/42

(52) U.S. Cl. 336/94; 220/646; 220/652

(57) ABSTRACT

A transformer tank having opposing walls and junctions between adjacent tank walls being intermediate walls defining obtuse angles with respect to each of their respective adjacent tank walls such that the tank is free from perpendicular wall intersections. Internal framework is disposed within the tank for preventing inward wall deflections and is anchored to the intermediate walls and is substantially free from attachment to the opposing walls. The tank undergoes volumetric expansion in response to increases in internal positive pressure to avoid tank rupture.

### TECHNICAL FIELD AND BACKGROUND OF THE INVENTION

1. Field of the Invention

The present invention relates generally to the field of transformer tank construction, and more particularly, to a rupture-resistant transformer tank designed to resist inward deflection of the tank walls in response to negative internal pressures while allowing outward deflection of the tank walls in response to internal fault pressures, such as from internal gaseous explosions, electrical faults and overcurrent conditions.

2. Background of the Invention

Transformer tanks of the type relating to the present invention are typically designed to house a transformer electrical core and coils immersed in transformer oil that both cools and insulates the windings. Conventional tank designs typically include a rectangular cube having a fixed volume that houses the power transformer and mitigates increases in pressure by way of a pressure relief device and by an externally attached expansion tank in fluid communication with the interior cavity of the transformer tank for receiving oil overflow. While the pressure relief device and expansion tank are typically able to accommodate minor and/or gradual increases in internal pressure, rapid increases in internal pressure resulting from internal faults, such as gaseous explosions and overcurrent conditions, can result in tank rupture in rigid-walled tanks constructed to resist wall deflections in response to positive and negative internal pressures.

Various highly complex attempts have been made to respond to pressure increases to prevent tank rupture by the release of oil and gas from the tank based upon an assumption that the tank geometry should be held intact. In these attempts, external bracing and other reinforcement members have been attached to, typically through welding, the exterior surfaces of the tank walls to prevent both inward/outward deflections caused by negative/positive pressures within the tank, respectively. For control of tank pressures, a separate tank (or tanks) is/are provided which communicate(s) with the main tank by valving and/or rupture discs. While external bracing advantageously strengthens the tank walls and provides ruggedness that protects the tank against external impact forces, in the case of an electrical fault within the tank, external bracing disadvantageously prevents outward deflection of the tank walls, thus fixing the volume of the tank and preventing the tank itself from accommodating volume increases to aid in pressure control. Along these same lines, internal structures designed to limit or subdue any expansive movements of the transformer tank walls resulting from pressures incurred by the fault conditions are also typically secured to the planar portions of the walls or used in combination with external bracing, thus preventing outward deflection of the walls to mitigate pressure increases.

Accordingly, it would be desirable to provide a transformer tank that overcomes the disadvantages of the prior art designs. Specifically, it would be desirable to provide transformer tank construction in which the tank itself is able to accommodate internal pressure increases through volumetric expansion of the tank, thus aiding and/or obviating the need for a pressure relief device and expansion tank from having to solely prevent tank rupture. The desirable tank construction embodiments provided herein include novel internal framework arrangements, reduce stress at wall intersections, provide deformable tank walls, and relocate ancillary, external components to vacate wall expansion space, among other features.

### BRIEF SUMMARY OF THE INVENTION

In one aspect, a transformer tank is provided configured to mitigate internal pressure increases through volumetric tank expansion.

In another aspect, a transformer tank is provided that mitigates internal pressure increases, regardless of location within the tank, through outward wall deflection, thus increasing tank volume and reestablishing internal pressure equilibrium.

In yet another aspect, a transformer tank is provided including internally reinforced walls for resisting inward deflection of the walls in response to negative internal pressures (e.g. vacuum) while allowing outward deflection of the walls in response to positive internal pressures.

In yet another aspect, a transformer tank is provided including internal framework for maintaining tank integrity during all modes of normal operation and during the pulling of a vacuum, such as during liquid-filling operations.

In yet another aspect, various transformer tank designs are provided including internal framework in which the framework has limited or no attachment to the planar portions of the tank walls, thus allowing outward deflection of the walls in response to internal pressures of sufficient magnitude as to risk tank rupture.

In yet another aspect, a transformer tank is provided configured to deform in shape (i.e. bulge) to maintain internal pressures below those required for tank rupture.

In yet another aspect, a transformer tank is provided including means for volumetric expansion and optionally at least one of a pressure relief device and expansion tank for together mitigating internal pressure increases.

In yet another aspect, a transformer tank is provided free of perpendicular wall intersections so as to distribute corner stresses and prevent tank rupture.

In yet another aspect, a transformer tank is provided including reinforced wall intersections.

In yet another aspect, a transformer tank is provided including internal corner bracing to which internal framework substantially free from attachment to the planar portions of the tank walls is attached, allowing outward deflection of the walls in response to internal pressure increases.

In yet another aspect, a transformer tank is provided free of corner welds.

In yet another aspect, a transformer tank is provided including outer restraints for limiting the outward movement of the planar wall sections at increased internal positive pressures.

In yet another aspect, external wall bracing is provided including wall supports that resists outward wall deflections at low internal positive pressures and fail at internal positive pressures of a magnitude great enough to cause tank rupture.

In yet another aspect, a transformer tank is provided having outer restraints with the capability of re-establishing planar characteristics of the tank walls following an internal pressure event.

In yet another aspect, a transformer tank is provided including internal framework that is welded to the planar portions of the wall sections, wherein the welds resist outward wall deflections at low internal positive pressures and fail at high internal positive pressures to allow the walls to deflect outward to avoid tank rupture.

In yet another aspect, alternative mounting positions for ancillary components are provided for leaving vacant the space immediately adjacent the exterior of the tank walls for outward wall deflection.

To achieve the foregoing and other aspects and advantages, in one embodiment a transformer tank is provided including a tank having opposing tank walls and junctions between adjacent tank walls being intermediate walls defining an obtuse angle with respect to each of their respective adjacent tank walls such that the tank is free from perpendicular wall intersections. The tank further includes internal bracing including internal corner braces attached to the intermediate walls and internal framework attached to the corner braces and positioned adjacent to and substantially detached from the tank walls in order to brace the walls against internal deflection from negative internal pressures while allowing outward deflection in response to positive internal fault pressures. In the preferred embodiment, the transformer tank undergoes volumetric expansion in response to rapid internal positive pressure increases to prevent tank rupture.

In additional and optional embodiments, the transformer tank includes one or more of engineered expansion zones for volumetric tank expansion, ancillary tank components mounted to the transformer tank through bracing that positions the components out of space adjacent the exterior of the opposing tank walls reserved for outward wall deflection, a pressure relief device positioned within a top wall of the tank, corrugated tank walls that distort to enhance volumetric tank expansion, flexible connections for allowing tank components to move with the tank walls during outward wall deflection while remaining connected, and internal framework including a plurality of interconnected independent braces.

In another embodiment, the tank includes external bracing positioned about the planar portions (i.e. sides) of the tank walls including wall supports configured to resist outward wall deflection in response to low/gradual internal positive pressure increases, and fail in response to high internal positive pressures to allow outward wall deflection to prevent tank rupture. In an alternative embodiment to achieve the same result, the tank includes internal bracing welded to the planar portions of the tank walls, wherein the welds resist outward wall deflection in response to low internal positive pressures and fail in response to high internal positive pressures to allow outward wall deflection and prevent tank rupture.

In another embodiment, the present invention provides a transformer tank including a tank defining a rectangular cube shape having opposing tank walls and junctions between adjacent tank walls being intermediate walls defining an obtuse angle with respect to each of their respective adjacent tank walls such that the tank is free from perpendicular wall intersections, a transformer electrical core and coils immersed in a predetermined volume of internal fluid housed within the tank, and internal framework substantially detached from the opposing tank walls to resist inward wall deflection while allowing outward wall deflection in response to internal positive pressure increases to expand tank volume and prevent tank rupture. Optionally, the tank further includes at least one of external bracing having wall supports and internal welding of the framework to the walls, each of which are configured to fail under internal positive pressures of a magnitude sufficient to cause tank rupture.

In additional and optional embodiments, the transformer tank includes internal corner braces attached to the intermediate walls and to the internal framework, engineered expansion zones for volumetric tank expansion, ancillary components mounted out of the deflection zones, and flexible connections for tank components.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of a transformer tank constructed in accordance with an embodiment of the invention;

FIG. 2 is a side elevation view illustrating outward tank wall deflection in response to internal positive pressure increases;

FIG. 3 is an overhead sectional plan view illustrating tank wall construction and corner bracing;

FIG. 4 is a detailed view of a portion of FIG. 3 illustrating outward wall deflection;

FIG. 5 is a fragmentary sectional view of a wall section including an engineered expansion zone and internal framework;

FIG. 6 is a side elevation view illustrating ancillary component placement outside of the wall deflection zones;

FIG. 7 is a perspective view of a transformer tank including external wall bracing having wall supports engineered to fail at predetermined internal positive pressures; and

FIG. 8 is an exploded view of a transformer tank including internal skeletal framework.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

Referring to the figures, a transformer tank in accordance with an embodiment of the invention is shown generally at reference numeral 10. Transformer tank 10 is of the basic type known to those skilled in the art for housing a transformer electrical core and coils immersed in transformer oil, for example, highly refined mineral oils, silicone-based oils and fluorinated hydrocarbons, among others, referred to herein collectively as the “internal fluid.” It is intended that transformer tank 10 may have any dimensions and may contain any predetermined volume/level of internal fluid. In a preferred embodiment, the predetermined volume of expansion tank fluid is greater than that normally provided in a rigid walled tank of corresponding size, thus maintaining an adequate internal fluid level as the tank walls deflect outward to increase tank volume.

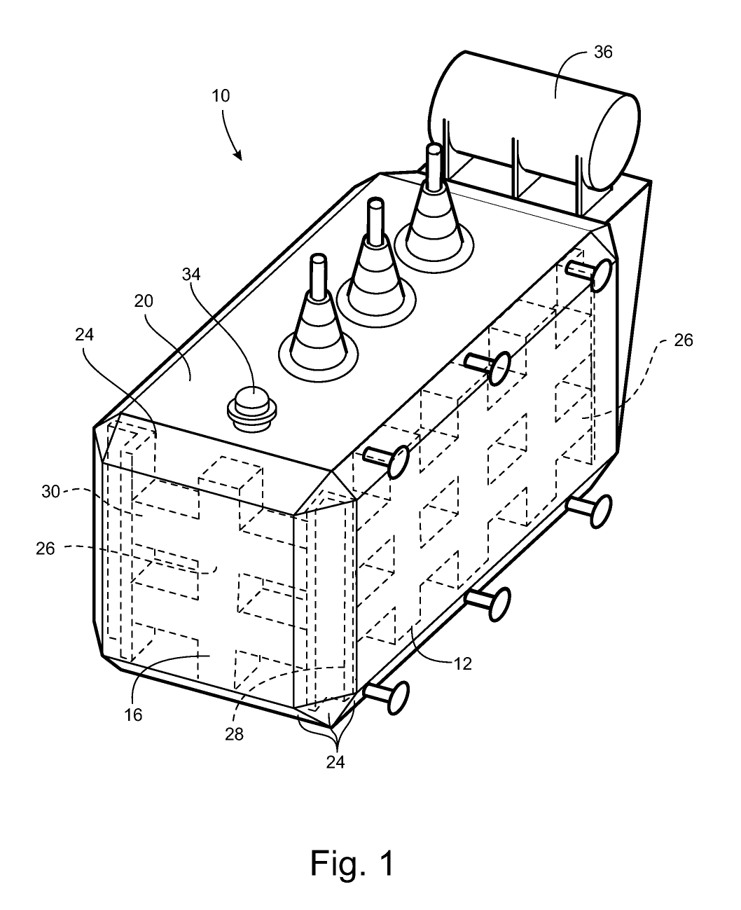

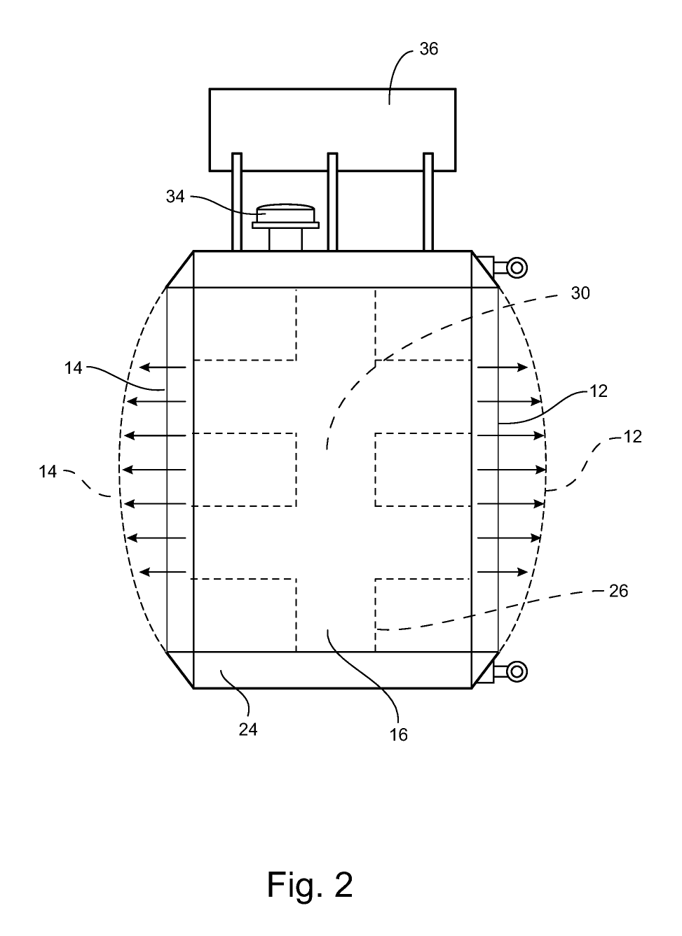

Referring to FIGS. 1-2, transformer tank 10 defines a generally rectangular cube shape devoid of perpendicular wall intersections to distribute stresses across greater angles and reduce corner stresses. Specifically, tank 10 includes a pair of opposing sides 12, 14 that generally define the length of the tank, a pair of opposing ends 16, 18 that generally define the width of the tank, a top 20, a bottom 22, and a plurality of fixed intermediate walls 24 interconnecting sides 12, 14, ends 16, 18, top 20 and bottom 22. The sides 12, 14 and ends 16, 18 of the tank are collectively referred to herein as the “walls” or the “sides”, and define generally planar surfaces that deflect outward in response to predetermined internal positive pressures.

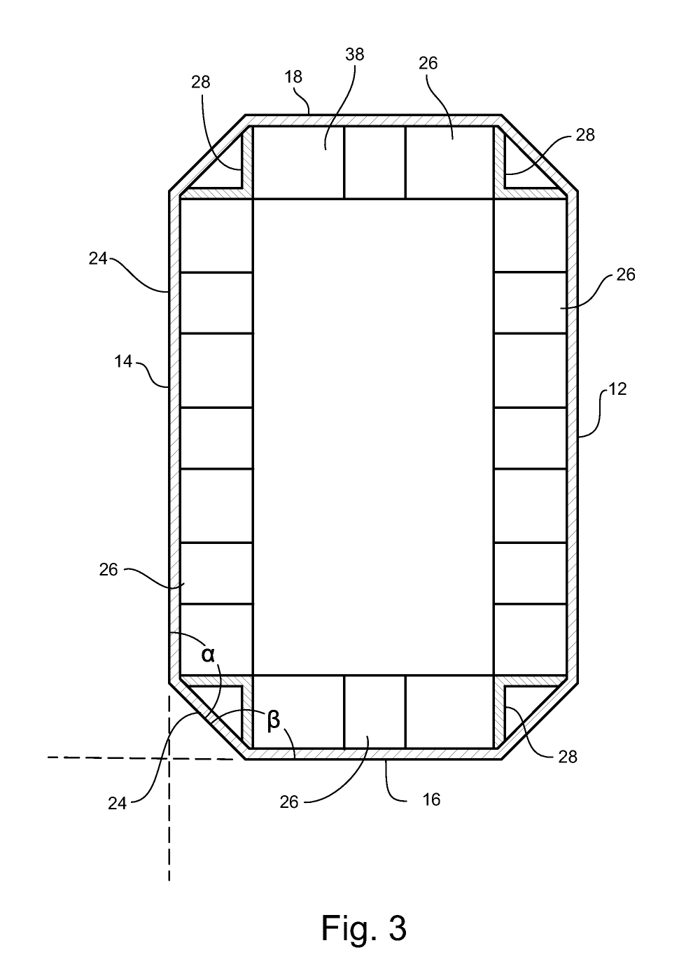

Intermediate walls 24 also define planar surfaces, but have significantly less surface area relative to their adjacent walls. Intermediate walls 24 are positioned at obtuse angles with respect to each of their adjacent walls, as described in detail below with reference to FIG. 3, and it is intended that intermediate walls 24 do not deflect outward in response to internal positive pressure increases. The incorporation of intermediate walls 24 to interconnect adjacent sides advantageously eliminates perpendicular wall intersections to provide a shape intermediate that of a box and a sphere to reduce corner stresses and convert stresses from bending to tensile. In the preferred embodiment, the walls deflect outward in response to internal positive pressure increases and resist inward deflection in response to negative internal pressures (i.e. vacuum), while top 20, bottom 22 and intermediate walls 24 resist deflection in both directions.

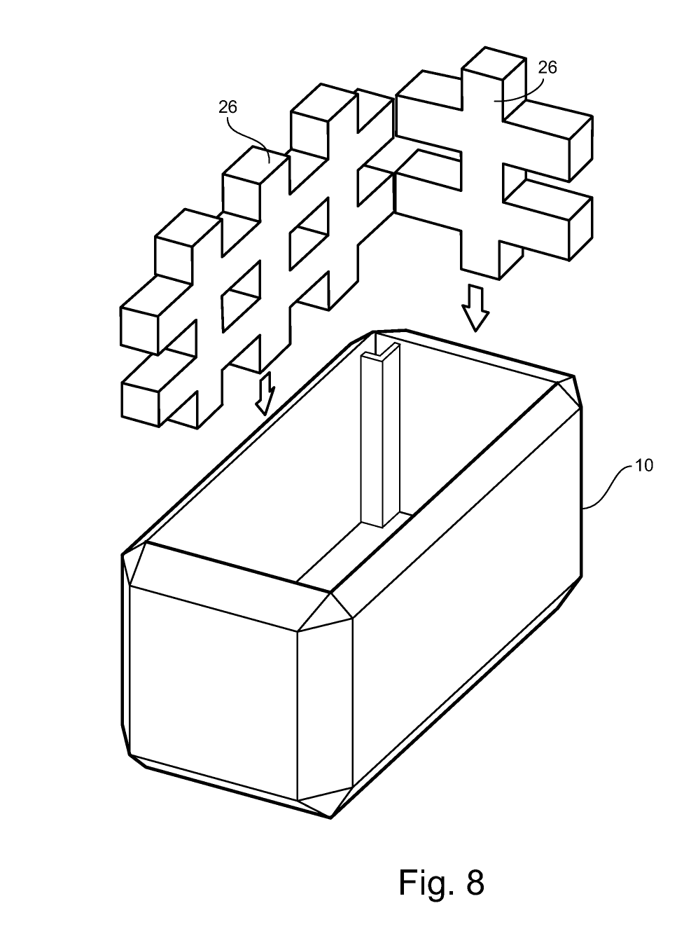

Rigid internal framework is provided within the tank interior for bracing the walls against damaging inward deflections while allowing outward deflection of the walls. Outward wall deflection is achieved through a lack of attachment, or limited attachment as described with reference to FIG. 8, of the internal framework to the walls. In one embodiment, the internal framework includes a plurality of interconnected vertical and horizontal members 26 secured to and between corner braces 28, which together cooperate to form an endoskeleton. Internal framework may optionally be positioned above and beneath the transformer core and coils and attached to top 20 and bottom 22, respectively, to resist deflection of the top and bottom in either direction to preserve the tank structure and ancillary components, their positions, and their respective connections.

The corner braces 28 are preferably welded or otherwise secured to the interior of the intermediate walls 24 to provide an anchor for the internal framework within tank 10. Corner braces 28 extend substantially the length of their respective planar face, have a width about equal to or less than the width of their respective planar face, and may be welded to the intermediate walls 24. In the embodiment shown, vertical members of the internal framework extend substantially the height of their respective wall and are spaced apart at predetermined intervals along the length of the wall. Vertical members located along the same wall are interconnected through one or more horizontal members such as cross member 30, that span the length of their respective wall, such as from corner member to corner member. The vertical and horizontal members may be integrally formed, may be secured together through welding, or may be connected through any suitable conventional fastener. Horizontal and/or vertical members are secured to the corner braces 28 through welding, bolting or other suitable fastener. The vertical and horizontal members are preferably positioned substantially flush against or slightly spaced apart from the interior surface of their respective wall to prevent inward wall deflection in response to negative internal pressures, such as from vacuum filling.

In an alternative embodiment, horizontal members alone may span the length of their respective wall and are secured to corner braces 28 to resist inward wall deflections. As with vertical members, the horizontal members are free from attachment, or have limited attachment, to the walls and may be spaced apart from one another and positioned substantially flush against the walls. Thus, in either embodiment, while the internal framework is secured to the interior of tank 10 through the corner braces, the framework is detached, or attached in a limited manner as described with regard to FIG. 8, from the walls to allow outward wall deflection. Limited attachment to the walls is intended to include attachment that does not prevent outward wall deflection in response to an internal pressure increase of a magnitude sufficient to require volumetric expansion of the tank to establish internal pressure equilibrium for the purpose of avoiding tank rupture. An example of limited attachment may include a limited number of welds and/or welds engineered to break under a predetermined pressure threshold, as described in detail below.

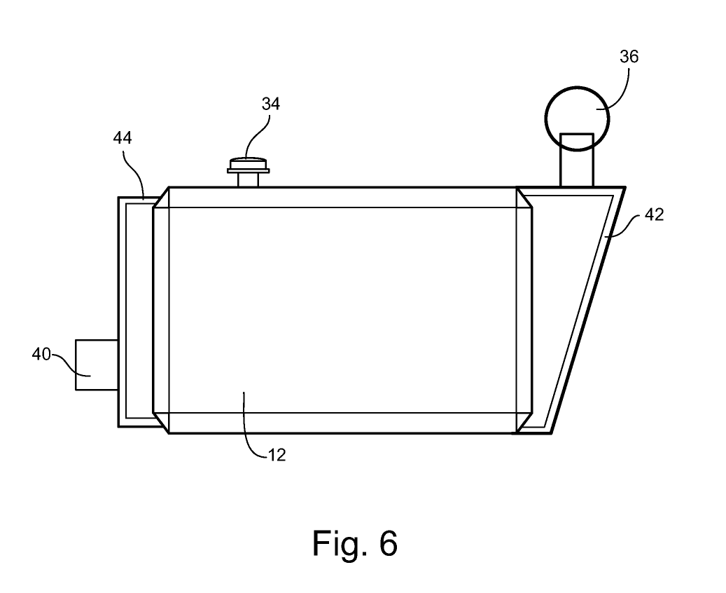

Tank 10 further includes one or more of the following ancillary components such as, but not limited to, a pressure relief device, an expansion tank, electrical connections, cooling radiators (or coolers), electric pumps for forced internal fluid circulation, a control cabinet, and de-energizing relays, among other components. Radiators, typically present in conventional transformer tanks, may be relocated to open through fixed surfaces, such as intermediate walls 24 in an exemplary embodiment. Pressure relief device 34 for releasing internal gas is preferably positioned within fixed top 20 of tank 10. Expansion tank 36 is preferably oversized as compared to conventional tank sizes to accommodate an increased-volume expanded tank. Novel mounting positions of several of the above referenced ancillary components as well as flexible connections are described in detail below with reference to FIG. 6.

Referring to FIG. 2, the volumetric expansion of tank 10 is shown provided by the outward deflection of the sides 12, 14 and the ends 16, 18. The outward deflection of the tank walls is indicated by the directional arrows. In the preferred embodiment, the tank wall is restrained for a pressure of at least 50 psi and volume increases effected by full wall movements are from about 1.0% to about 2.0% by the outward deflection of the tank walls, more preferably from about 1.5% to about 2.5%. It is envisioned that greater volume increases can be achieved.

Referring to FIG. 3, a sectional overhead plan view of tank 10 is shown to illustrate wall angles and corner braces 28. The generally rectangular cube shape of tank 10 is shown constructed from walls 12, 14, 16 and 18 and intermediate walls 24. Intermediate walls 24 are further intermediate bottom 22 and top 20 (not shown). Angled intermediate walls 24 are preferably achieved through bending as opposed to welding sections together where possible to achieve strength at wall intersections. Bends preferably result in obtuse angles between wall and intermediate wall 24 intersections. In FIG. 3, intermediate wall 24 is shown oriented at an obtuse angle with respect to side 14, indicated by angle α, and at an obtuse angle with respect to end 18, indicated by angle β. As compared to conventional tank construction in which adjacent walls are oriented perpendicular to one another. Thus, adjacent walls of the present construction are oriented at greater angles with respect to one another to distribute stress.

In preferred embodiments, the wall sections are welded together at locations away from corners. To increase the strength at wall intersections, additional angle braces 38 may be continuously welded to the interior surface of intermediate walls 24 to strengthen corners and prevent the outward deflection of intermediate walls 24. Rigid corner braces 28, and optionally angle braces 38, in the embodiment shown have an angled cross-section to provide strength and adequate surface area for securing the internal framework thereto. In alternative embodiments, it is envisioned that corner braces 28 may have alternative shapes and additional strengthening bracing apart from the walls may be provided.

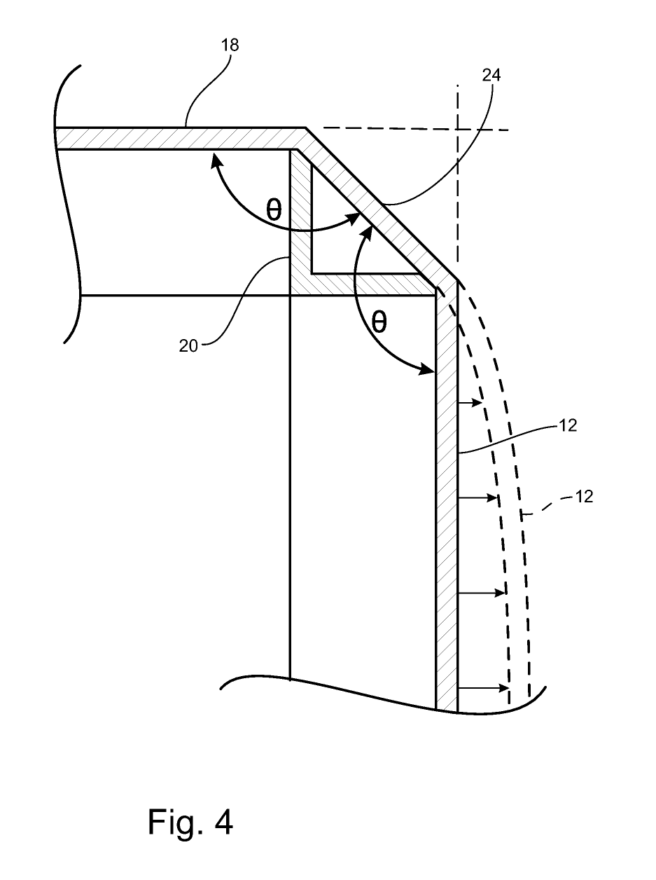

Referring to FIG. 4, a detailed view of a wall intersection is shown illustrating a displaced side/end wall. As shown, side 12 is displaced outward from its initial position in response to an increase in internal positive pressure. The elimination of perpendicular wall intersections and the avoidance of welds at the corners provide strength and reduce stress from the outward movement of sides 12, 14 and ends 16, 18.

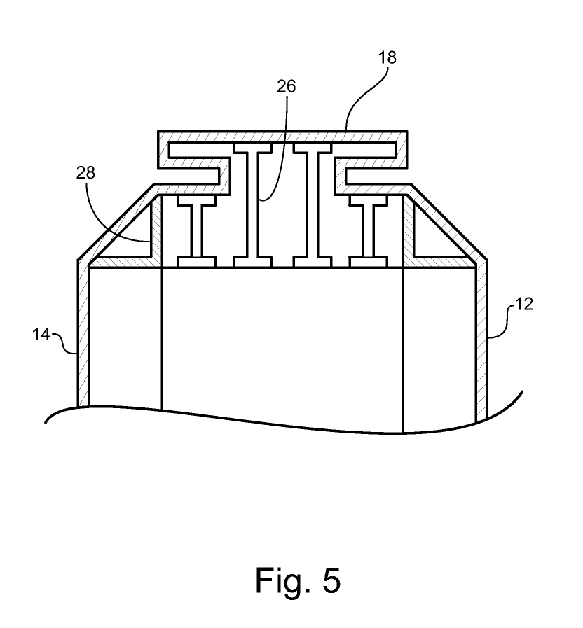

Referring to FIG. 5, in a further embodiment, transformer tank 10 includes engineered expansion design for walls 12, 14, 16, and 18 for increasing tank volume to reestablish pressure equilibrium in response to internal positive pressure increases. Under pressure, the outermost portion of end 18 moves outward away from the tank, causing the folded wall sections to straighten and extend to the degree necessary. Expansion zones may be provided in one or more of sides 12, 14 and ends 16, 18. As shown, the expansion zone includes a folded wall section that moves outward in response to the internal pressure. Folds in the wall may be accomplished by welding or through the use of reduced gauge steel. Positioned inward of end 18 are a plurality of vertical braces having an I-beam cross-section. As shown, braces of a lesser height whose position corresponds to the folded section are positioned inward of and adjacent to a folded section, while braces positioned apart from a folded section having a greater height.

Referring to FIG. 6, components conventionally installed on tank walls that either depend upon a planar surface for mounting and/or provide unwanted stiffness to the tank wall (e.g. control cabinets) are preferably mounted remotely or on braces supported by stationary regions of the tank. As shown, ancillary components such as expansion tank 36 and control cabinet 40 are mounted upon braces 42, 44, respectively, for positioning the components away from the exterior walls of tank 10 to vacate the deflection region of walls 12, 14, 16 and 18. Braces 42, 44 are preferably mounted to stationary tank surfaces, for example, corners, top 20, bottom 22 and intermediate walls 24. Braces 42, 44 preferably include generally horizontal, vertical and angled members that cooperatively maintain and support component positions during an internal fault event and during the life of the transformer tank. Components required to be mounted on a flexible sidewall or end wall (e.g. rapid rise relay, oil/winding temperature well, etc.) may be mounted using flexible connections to allow movement with their respective wall during deflection without breakage or loss of connection. In a specific embodiment, the tank 10 includes a minimum of two oversized pressure relief devices to maximize oil release during a pressure transient.

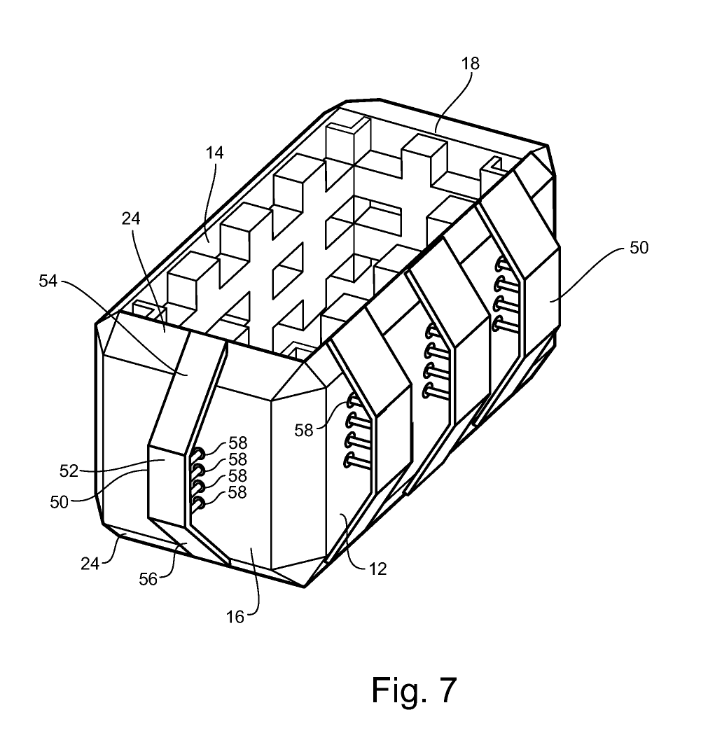

Referring to FIG. 7, a further embodiment of a transformer tank is provided including external wall bracing configured to resist inward wall deflection in response to negative internal pressures, and include components that fail under positive internal pressures significant enough to cause outward wall deflection to establish internal pressure equilibrium. Thus, the planar walls are restrained under normal operating pressures without excessive deflection. Specifically, external brackets 50 are positioned vertically and are spaced-apart along the length of the walls 12, 14, 16 and 18. Brackets 50 define planar portions 52 oriented generally parallel to their underlying planar wall surface, and upper and lower angled portions 54 and 56, respectively, that correspond to generally the angle of their respective intermediate wall 24 to which they are attached in order to support portions 52 apart from their underlying wall. It is envisioned that alternative bracket structures may be achieved to provide the same result of spacing the portions of the bracket adjacent the deflection zones apart from their underlying wall.

Brackets 50 include screw jacks or other fasteners, referred to generically as “wall supports” shown at reference numeral 58, secured to the interior surfaces of portions 52 that extend between the bracket 50 and underlying wall within the wall deflection zones. The wall supports 58 press against the walls and internal bracing, and are configured to “fail”, such as by breakage, bending, compressing, telescoping inward, etc., at internal positive pressures that threaten tank rupture. Thus, under such pressures, the walls are permitted to deflect outward, and that outward deflection is limited by the “give” of the wall supports 50 and the distance of the rigid portion 52 of the brackets 50 from the underlying wall. In one embodiment, the wall supports 58 are resilient, and thus restore the walls to planar subsequent to the internal pressure event. Restoring the walls to planar may also be achieved by pulling a vacuum to return the walls back against the internal braces and restore the wall supports 58 to their original positions. As the brackets 50 are rigid and fixed, they may serve as mounting points for ancillary components.

Referring to FIG. 8, another embodiment for resisting inward wall deflection and restraining outward wall deflection under normal operating pressures (i.e. positive) is shown. In this embodiment, the internal framework welded or bolted to the corner braces as described in detail above is further welded, or otherwise attached, at predetermined positions to the interior surface of the walls. The welds or other fasteners are configured to fail in the event of positive internal pressures threatening tank rupture. As shown, the internal braces include vertical and horizontal members forming a skeletal framework for bracing the walls against inward wall deflections.

While various transformer tank constructions have been provided with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A transformer tank, comprising:
a tank having opposing tank walls and junctions between adjacent tank walls being intermediate walls defining an obtuse angle with respect to each of their respective adjacent tank walls such that the tank is free from perpendicular wall intersections;
internal corner braces attached to the intermediate walls; and
internal framework attached to the corner braces and positioned adjacent to and substantially detached from the tank walls to brace the walls against internal deflections from negative internal pressures while allowing outward deflections in response to positive internal pressures that threaten tank rupture;
wherein the transformer tank undergoes volumetric expansion in response to increases in internal positive pressure to avoid tank rupture.

2. The transformer tank according to claim 1, further comprising external bracing including at least one bracket secured to the tank at the intermediate walls and including a planar portion positioned apart from its respective underlying one of the opposing tank walls, the planar portion carrying a plurality of wall supports extending between the planar portion and the underlying one of the opposing tank walls configured to fail in response to positive internal pressures that threaten tank rupture.

3. The transformer tank according to claim 1, wherein the opposing tank walls include engineered expansion zones for volumetric tank expansion.

4. The transformer tank according to claim 2, wherein the expansion zones comprise folded wall sections configured to extend outward with respect to the tank interior in response to rapid internal positive pressure increases.

5. The transformer tank according to claim 1, further comprising an internal fluid expansion tank mounted to the transformer tank through bracing that positions the expansion tank out of space adjacent the exterior of the opposing tank walls.

6. The transformer tank according to claim 1, further comprising at least one pressure relief device.

7. The transformer tank according to claim 1, wherein the internal framework includes a plurality of vertical and horizontal members that are interconnected and span substantially the length of their respective wall, and the opposing tank walls include only sides and ends of the tank.

8. The transformer tank according to claim 1, wherein ancillary tank components associated with the opposing tank walls are connected with flexible connections to allow movement with the opposing tank walls during outward wall deflection.

9. The transformer tank according to claim 1, further comprising welds that attach the internal framework to the opposing tank walls, wherein the welds are configured to fail to allow outward wall deflection in response to positive internal pressures that threaten tank rupture.

10. A transformer tank, comprising:
a tank defining a rectangular cube shape having opposing walls and junctions between adjacent tank walls being intermediate walls disposed at obtuse angles with respect to each of their respective adjacent walls such that the tank is free from perpendicular wall intersections;
a transformer electrical core and coils immersed in a predetermined volume of internal fluid housed within the tank; and
internal framework positioned adjacent to the opposing tank walls to resist inward wall deflections in response to negative internal pressures while allowing outward wall deflections in response to positive internal pressures to expand tank volume and avoid tank rupture.

11. The transformer tank according to claim 10, further comprising external bracing including at least one bracket secured to the tank at the intermediate walls and including a planar portion positioned apart from its respective underlying one of the opposing tank walls, the planar portion carrying a plurality of wall supports extending between the planar portion and the underlying one of the opposing tank walls configured to fail in response to positive internal pressures that threaten tank rupture.

12. The transformer tank according to claim 10, further comprising internal corner braces attached to the intermediate walls and to the internal framework.

13. The transformer tank according to claim 10, wherein the opposing tank walls include engineered expansion zones to increase tank volume.

14. The transformer tank according to claim 12, wherein the expansion zones comprise folded wall sections configured to extend outward relative to the tank interior in response to rapid internal positive pressure increases.

15. The transformer tank according to claim 10, further comprising an internal fluid expansion tank mounted to the transformer tank and expansion tank bracing that positions the expansion tank out of space adjacent the exterior of the opposing tank walls reserved for outward wall deflection.

16. The transformer tank according to claim 10, wherein ancillary tank components associated with the opposing tank walls are connected with flexible connections to allow movement with the opposing tank walls during outward wall deflection.

17. The transformer tank according to claim 10, further comprising welds that attach the internal framework to the opposing tank walls, wherein the welds are configured to fail to allow outward wall deflection in response to positive internal pressures that threaten tank rupture.
